(19) United States
(12) Patent Application Publication
(10) Pub. No.: US 2009/0253395 A1
(43) Pub. Date: Oct. 8, 2009

(54) ANTENNA INPUT TUNING CIRCUIT

(75) Inventors: Takeshi Ikeda, Tokyo (JP); Hiroshi Miyagi, Kanagawa (JP)

Correspondence Address: CONNOLLY BOVE LODGE & HUTZ LLP, 1875 EYE STREET, N.W., SUITE 1100, WASHINGTON, DC, 20006, US

(73) Assignee: NUERO SOLUTION CORP., Setagaya-ku, Tokyo (JP)

(21) Appl. No.: 12/303,157

(22) PCT Filed: Feb. 6, 2007
(86) PCT No.: PCT/JP2007/052442

§ 371 Date: Dec. 2, 2008

(30) Foreign Application Priority Data
Jun. 2, 2006 (JP) 2006-154642

(51) Int. Cl. H04B 1/18

(52) U.S. Cl. 455/193.1

(57) ABSTRACT

There are provided a variable tuning filter 11 for selecting any of resistance elements by changing over a switch to cause a tuning frequency f_{F} to be variable, and an oscillating circuit 12 constituted in the same manner as the variable tuning filter 11, and an oscillating frequency f_{L} of the oscillating circuit 12 which is monitored by a frequency counter 13 and a desirable received frequency fᵣ which is preset by a control circuit 14 are compared with each other based on respective frequency count values, and the oscillating frequency f_{L} of the oscillating circuit 12 is varied in such a manner that both of the frequencies are coincident with each other within an allowable error range, and correspondingly, the tuning frequency f_{F} of the variable tuning filter 11 is also varied. Consequently, it is possible to adjust the tuning frequency f_{F} of the variable tuning filter 11 to be coincident with the desirable received frequency fᵣ without using a variable capacitance diode which is hard to integrate or the like.

### FIELD OF THE INVENTION

The present invention relates to an antenna input tuning circuit and more particularly to an antenna input tuning circuit for selecting a frequency of a radio frequency signal which is obtained upon receipt of a broadcasting electric wave through an antenna.

### DESCRIPTION OF THE RELATED ART

In general, a radio receiver is constituted as shown in FIG. 1. More specifically, an extremely low power radio frequency signal (RF signal) obtained upon receipt of a broadcasting electric wave through an antenna 101 is amplified by a radio frequency amplifying circuit 102 and is then frequency-selected by an antenna input tuning circuit 103 in order to enhance a noise factor or to improve a disturbing characteristic. A signal output from the antenna input tuning circuit 103 is mixed with a local oscillating signal generated from a local oscillating circuit 104 and is frequency-converted into an intermediate frequency signal (IF signal) in a mixer circuit 105.

The intermediate frequency signal output from the mixer circuit 105 also includes a signal component other than a desirable frequency band. Therefore, the signal output from the mixer circuit 105 is supplied to an IF filter 106 so that only an intermediate frequency signal of the desirable frequency band is fetched. The intermediate frequency signal is amplified by an intermediate frequency amplifying circuit 107. Then, the intermediate frequency signal thus amplified is detected by a detecting circuit 108 and is demodulated as an audio signal, and the audio signal is supplied via an audio amplifying circuit 109 to a speaker 110.

With the structure described above, an intermediate frequency has a fixed value and a received frequency is determined by varying a value of a local oscillating frequency. Accordingly, a difference between a tuning frequency of the antenna input tuning circuit 103 and a tuning frequency (a local oscillating frequency) of the local oscillating circuit 104 is set to be the intermediate frequency. More specifically, if the tuning frequency of the antenna input tuning circuit 103 is represented by fᵣ, the intermediate frequency is represented by fᵢ and the local oscillating frequency of the local oscillating circuit 104 is represented by fₒ, fᵣ=fₒ−fᵢ is to be always established irrespective of the tuning frequency fᵣ or the local oscillating frequency fₒ in case of an upper heterodyne.

In general, the tuning circuit is constituted by a resonant circuit obtained by combining a coil and a capacitor in parallel (or in series). A tuning method of changing the tuning frequency in the tuning circuit includes an analog method using a variable capacitor (a variable condenser) or the like and a digital method using a variable capacitance diode (a varicap diode) or the like (see Patent Documents 1 to 3, for example).

Patent Document 1: Japanese Laid-Open Patent Publication No. 9-98102

Patent Document 2: Japanese Laid-Open Patent Publication No. 9-102752

Patent Document 3: Japanese Laid-Open Patent Publication No. 9-181571

In the analog method, a tuning knob is turned to continuously change the tuning frequency of the antenna input tuning circuit 103 and the local oscillating frequency of the local oscillating circuit 104, thereby selecting a desirable received frequency. In the analog method, a tuning circuit constituted by using an MOSFET-C filter is also provided. The MOSFET-C filter is constituted by combining an MOSFET to be used as a resistor and a capacitor. It is possible to set the tuning frequency to be variable by varying a gate-source voltage Vgs of the MOSFET to change a characteristic of the filter.

In the case in which the tuning circuit is constituted by the MOSFET-C filter, however, the tuning frequency cannot be changed beyond a variation in the gate-source voltage Vgs. For this reason, a dynamic range is reduced. Moreover, an ON resistance of the MOSFET has a great variation in a characteristic due to a manufacturing process and the tuning frequency is hard to adjust accurately. Furthermore, there is also a problem in that a noise is made from the MOSFET itself.

On the other hand, in the digital method, the local oscillating circuit 104 is set to have a PLL (Phase Locked Loop) structure and a control voltage to be supplied to a voltage controlled oscillator (VCO) included in the PLL is varied by controlling a frequency dividing ratio of a variable frequency divider included in the PLL. With the control voltage, the tuning frequency of the antenna input tuning circuit 103 and the local oscillating frequency of the local oscillating circuit 104 are discretely changed to select the desirable received frequency. The frequency dividing ratio of the variable frequency divider is given from a microcomputer, for example.

In case of the digital method, for example, it is possible to select a broadcast having a desirable received frequency by presetting a plurality of frequency dividing ratios to a memory corresponding to a plurality of buttons to simply push any of the buttons. More specifically, it is not necessary to carry out a fine control through the tuning knob as in the analog method. Therefore, there is a feature that a usability is excellent. Moreover, the problems of a dynamic range, a variation in a characteristic due to a manufacturing process, and a noise are also lessened as compared with the analog method. For this reason, a large number of recent radio receivers employ the digital tuning method.

In the case in which the radio receiver constituted by the digital tuning method is subjected to an integration, however, a variable capacitance diode, a coil and the like which constitute the antenna input tuning circuit 103 and the VCO for the local oscillating circuit 104 cannot be integrated but are to be external components of an IC. Thus, the conventional radio receiver using the digital method has a problem in that the number of the external components is increased in the integration and a cost is thus increased.

### DISCLOSURE OF THE INVENTION

In order to solve the problems, it is an object of the present invention to enable the number of external components to be decreased when integrating an antenna input tuning circuit employing a digital tuning method.

Moreover, it is another object of the present invention to suppress a variation in a characteristic due to a manufacturing process and a generation of a noise, thereby enabling a tuning frequency to be adjusted more accurately.

In order to attain the objects, an antenna input tuning circuit according to the present invention includes a variable tuning filter constituting an RC active filter by using a plurality of resistance elements and formed to determine a tuning frequency through a selection of any of the resistance elements by changing over a switch, an oscillating circuit constituted in the same manner as the variable tuning filter, a frequency counter for counting an oscillating frequency of the oscillating circuit, and a switch change-over circuit for comparing a target count value corresponding to a desirable received frequency with a count value of the frequency counter and controlling the change-over of the switch depending on a result of the comparison.

According to another aspect of the present invention, the variable tuning filter and the oscillating circuit are disposed in the vicinity in a semiconductor chip. In this case, it is preferable that the frequency counter should add a predetermined amount of offset to the oscillating frequency of the oscillating circuit to carry out a counting operation.

According to the present invention having the structure described above, the oscillating frequency of the oscillating circuit which is monitored by the frequency counter and a preset desirable received frequency are digitally compared with each other based on the count value and the oscillating frequency of the oscillating circuit is set to be variable by changing over the switch in such a manner that both of the frequencies are coincident with each other (a predetermined error range may be permitted), and the tuning frequency of the variable tuning filter is correspondingly set to be variable by changing over the switch. The variable tuning filter and the oscillating circuit are formed on the same semiconductor chip. Therefore, both variations in characteristics are generated in the same direction. By monitoring the oscillating frequency of the oscillating circuit to adjust the tuning frequency and similarly adjusting the tuning frequency in the variable tuning filter, accordingly, it is possible to reduce a shift from the desirable received frequency.

The oscillating circuit and the variable tuning filter have the same structures and both of them are constituted by the RC active filter, and it is not necessary to use a variable capacitor and a variable capacitance diode which are hard to integrate. Consequently, it is possible to decrease the number of the external components and to easily integrate the antenna input tuning circuit and the radio receiver using the antenna input tuning circuit. According to the present invention, moreover, the MOSFET-C filter is not used. Therefore, it is also possible to improve the problems of the dynamic range, the variation in a characteristic due to a manufacturing process and an FET noise.

According to another feature of the present invention, furthermore, the variable tuning filter and the oscillating circuit are disposed close to each other. Therefore, the variation in a characteristic due to a manufacturing process between the variable tuning filter and the oscillating circuit can be reduced more greatly. Consequently, it is possible to reduce a shift between the tuning frequency adjusted by monitoring the oscillating frequency of the oscillating circuit and the desirable received frequency, thereby controlling the tuning frequency of the antenna input tuning circuit more accurately.

According to a further feature of the present invention, a predetermined amount of offset is added to the oscillating frequency of the oscillating circuit to carry out a counting operation. Consequently, it is possible to cause the oscillating frequency of the oscillating circuit and the tuning frequency of the variable tuning filter to have a difference. In the case in which the variable tuning filter and the oscillating circuit which have the same circuit structures are disposed close to each other, a signal oscillated by the oscillating circuit is sent around the variable tuning filter to make a noise if the oscillating frequency of the oscillating circuit is equal to the tuning frequency of the variable tuning filter. On the other hand, it is possible to suppress an occurrence of the noise by causing the oscillating frequency of the oscillating circuit and the tuning frequency of the variable tuning filter to have a difference.

### BRIEF DESCRIPTION OF THE DRAWINGS

FIG. 1 is a diagram showing a structure of a general radio receiver,

FIG. 2 is a diagram showing an example of a structure of a radio receiver to which an antenna input tuning circuit according to the present embodiment is applied,

FIG. 3 is a diagram showing an example of a structure of the antenna input tuning circuit according to the present embodiment, and

FIG. 4 is a diagram showing an example of a structure of a variable tuning filter according to the present embodiment.

### BEST MODE FOR CARRYING OUT THE INVENTION

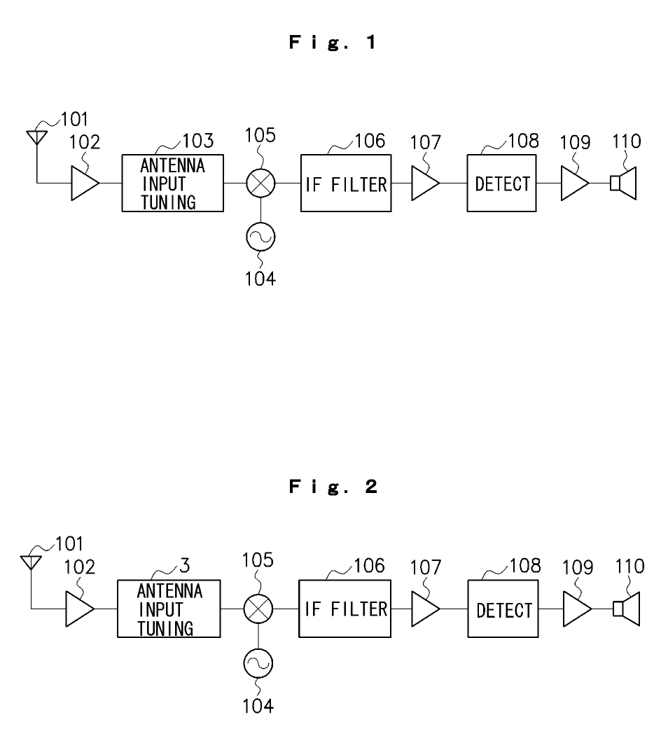

An embodiment according to the present invention will be described below with reference to the drawings. FIG. 2 is a diagram showing an example of a structure of a radio receiver to which an antenna input tuning circuit according to the present embodiment is applied. In FIG. 2, components having the same functions as those shown in FIG. 1 have the same reference numerals. The respective components shown in FIG. 2 (excluding an antenna 101, an audio amplifying circuit 109 and a speaker 110) are integrated into a single semiconductor chip through a CMOS (Complementary Metal Oxide Semiconductor) process, for example.

In FIG. 2, an extremely low power radio frequency signal (RF signal) obtained upon receipt of a broadcasting electric wave through the antenna 101 is amplified by a radio frequency amplifying circuit 102 and is then frequency-selected by an antenna input tuning circuit 3 according to the present embodiment in order to enhance a noise factor or to improve a disturbing characteristic. A signal output from the antenna input tuning circuit 3 is mixed with a local oscillating signal generated from a local oscillating circuit 104 and is frequency-converted into an intermediate frequency signal (IF signal) in a mixer circuit 105.

The intermediate frequency signal output from the mixer circuit 105 also includes a signal component other than a desirable frequency band. Therefore, the signal output from the mixer circuit 105 is supplied to an IF filter 106 so that only an intermediate frequency signal of the desirable frequency band is fetched. The intermediate frequency signal is amplified by an intermediate frequency amplifying circuit 107. Then, the intermediate frequency signal thus amplified is detected by a detecting circuit 108 and is demodulated as an audio signal, and the audio signal is supplied via the audio amplifying circuit 109 to the speaker 110.

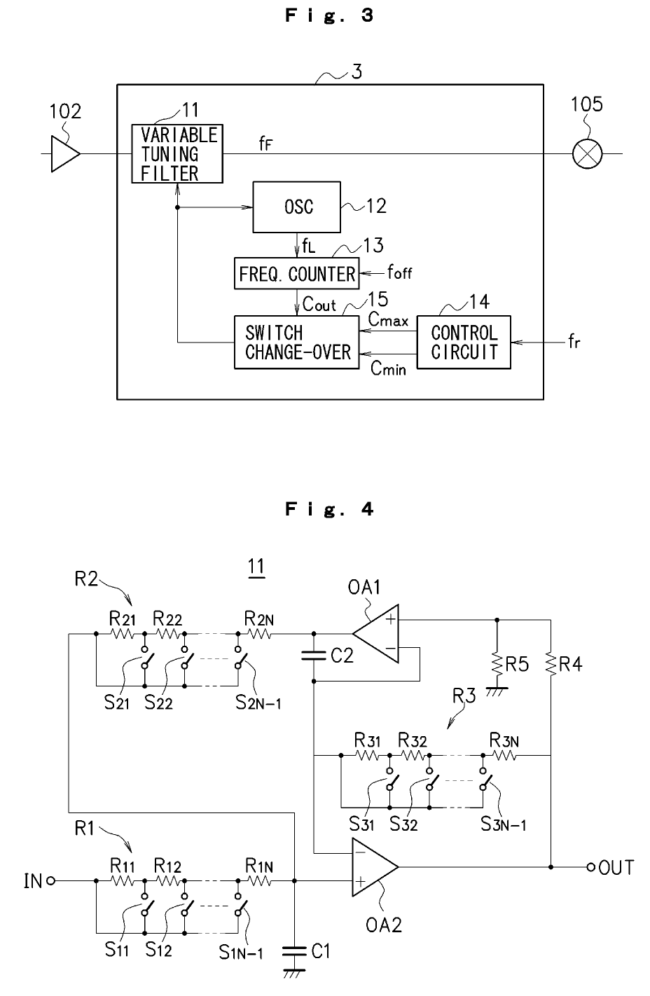

FIG. 3 is a diagram showing an example of a structure of the antenna input tuning circuit 3 according to the present embodiment. As shown in FIG. 3, the antenna input tuning circuit 3 according to the present embodiment includes a variable tuning filter 11, an oscillating circuit 12, a frequency counter 13, a control circuit 14 and a switch change-over circuit 15.

The variable tuning filter 11 has a capacitor, a plurality of resistance elements, and a switch for selecting any of the resistance elements. A tuning frequency f_{F} is determined based on a resistance value of any of the resistance elements which is selected by the switch and a capacitance value of the capacitor.

The oscillating circuit 12 has the same structure as that of the variable tuning filter 11 and is formed to determine an oscillating frequency f_{L} based on the resistance value of any of the resistance elements which is selected by the switch and the capacitance value of the capacitor. The variable tuning filter 11 and the oscillating circuit 12 are disposed in the vicinity in a semiconductor chip.

The frequency counter 13 counts the oscillating frequency f_{L} of the oscillating circuit 12 and outputs a count value Cout to the switch change-over circuit 15. The frequency counter 13 adds a predetermined amount of frequency offset f_{off} to the oscillating frequency f_{L} of the oscillating circuit 12 to carry out a counting operation. More specifically, if a count value corresponding to the oscillating frequency f_{L} of the oscillating circuit 12 is represented by C_{L} and a count value corresponding to the frequency offset f_{off} is represented by C_{off}, a count value output from the frequency counter 13 is represented by Cout=C_{L}+C_{off}.

The control circuit 14 sets a target count value corresponding to a desirable received frequency fᵣ of a broadcast wave selected by a user (a frequency to be set to the tuning frequency f_{L} of the variable tuning filter 11). An error tolerance in a predetermined amount is set to the target count value. More specifically, if an allowable error is represented by ±Δ, the control circuit 14 sets a target upper limit count value Cmax corresponding to an upper limit frequency fᵣ+Δ and a target lower limit count value Cmin corresponding to a lower limit frequency fᵣ−Δ. The control circuit 14 is constituted by a microcomputer or a DSP (Digital Signal Processor), for example.

The switch change-over circuit 15 compares the count value Cout counted by the frequency counter 13 with the target count values Cmax and Cmin set by the control circuit 14, and controls switches of the variable tuning filter 11 and the oscillating circuit 12 depending on a result of the comparison. A specific method of controlling the switch will be described below with reference to FIG. 4.

FIG. 4 is a diagram showing an example of a structure of the variable tuning filter 11 according to the present embodiment. As shown in FIG. 4, the variable tuning filter 11 according to the present embodiment is a two-stage amplifier type filter circuit (DABP: Dual-Amplifier Bandpass Filter) constituted by using two operational amplifiers OA1 and OA2, and a Q value can be increased. In the present embodiment, a resistor to be a component of the DABP is constituted by a plurality of resistance elements and a connecting state thereof is changed over by a switch.

More specifically, as shown in FIG. 4, a resistor R1 has a structure in which N (N is an integer of two or more) resistance elements R₁₁, R₁₂, . . . , R_{1N} are connected in series. Resistance values of the resistance elements R₁₁, R₁₂, . . . , R_{1N} may be equal to each other or different from each other. Similarly, a resistor R2 has a structure in which N resistance elements R₂₁, R₂₂, . . . , R_{2N} are connected in series. Resistance values of the resistance elements R₂₁, R₂₂, . . . , R_{2N} may be equal to each other or different from each other.

A resistor R3 also has a structure in which N resistance elements R₃₁, R₃₂, . . . , R_{3N} are connected in series. Resistance values of the resistance elements R₃₁, R₃₂, . . . , R_{3N} may be equal to each other or different from each other. R₂₁=R₃₁, R₂₂=R₃₂, . . . , R_{2N}=R_{3N} are set.

S₁₁, S₁₂, . . . , S_{1N-1} indicate (N−1) switches for selecting any of the N resistance elements R₁₁, R₁₂, . . . , R_{1N}, and S₂₁, S₂₂, . . . , S_{2N-1} indicate (N−1) switches for selecting any of the N resistance elements R₂₁, R₂₂, . . . , R_{2N}. Moreover, S₃₁, S₃₂, . . . , S_{3N-1} indicate (N−1) switches for selecting any of the N resistance elements R₃₁, R₃₂, . . . , R_{3N}.

The resistance elements R₁₁ to R_{1N} and the switches S₁₁ to S_{1N-1} are ladder connected and one of the switches is turned ON to select the resistance elements to be connected in series. For example, when the first switch S₁₁ is turned ON, the first resistance element R₁₁ is short-circuited and the second and succeeding resistance elements R₁₂, . . . , R_{1N} are connected in series.

Similarly, the resistance elements R₂₁ to R_{2N} and the switches S₂₁ to S_{2N-1} are ladder connected and one of the switches is turned ON to select the resistance elements to be connected in series. For example, when the first switch S₂₁ is turned ON, the first resistance element R₂₁ is short-circuited and the second and succeeding resistance elements R₂₂, . . . , R_{2N} are connected in series.

In the same manner, the resistance elements R₃₁ to R_{3N} and the switches S₃₁ to S_{3N-1} are ladder connected and one of the switches is turned ON to select the resistance elements to be connected in series. For example, when the first switch S₃₁ is turned ON, the first resistance element R₃₁ is short-circuited and the second and succeeding resistance elements R₃₂, . . . , R_{3N} are connected in series.

In the switches S₂₁ to S_{2N-1} in the resistor R2 and the switches S₃₁ to S_{3N-1} in the resistor R3, ith switches (i=1 to N−1) are turned ON synchronously. More specifically, the resistance values of the resistors R2 and R3 are always set to be equal to each other. On the other hand, referring to the switches S₁₁ to S_{1N-1} in the resistor R1, the ith switches (i=1 to N−1) do not need to be turned ON synchronously in a relationship between the switches S₂₁ to S_{2N-1} in the resistor R2 and the switches S₃₁ to S_{3N-1} in the resistor R3.

In the variable tuning filter 11 thus constituted, any set of switches S₁ⱼ, S₂ᵢ and S₃ᵢ are turned ON (i≠j may be set or i=j may be set). Consequently, the resistance values of the resistors R1, R2 and R3 to be connected to the operational amplifiers OA1 and OA2 can be variable.

The resistor R1 is used for adjusting the Q value and the resistors R2 and R3 are used for adjusting the tuning frequency. The Q value of the variable tuning filter 11 is determined based on a combined resistance value related to a series connection of any of the resistance elements R₁₁ to R_{1N} which are selected by the switches S₁₁ to S_{1N-1} and a capacitance value of a capacitor C1. Moreover, the tuning frequency of the variable tuning filter 11 is determined based on a combined resistance value related to a series connection of any of the resistance elements R₂₁ to R_{2N} and R₃₁ to R_{3N} which are selected by the switches S₂₁ to S_{2N-1} and S₃₁ to S_{3N-1} and a capacitance value of a capacitor C2.

The switches S₁₁ to S_{1N-1}, S₂₁ to S_{2N-1} and S₃₁ to S_{3N-1} are controlled by the switch change-over circuit 15. More specifically, the switch change-over circuit 15 controls to turn ON any of the switches S₁₁ to S_{1N-1}, S₂₁ to S_{2N-1}, and S₃₁ to S_{3N-1} depending on a result of the comparison between the count value Cout counted by the frequency counter 13 and the target count values Cmax and Cmin set by the control circuit 14.

As described above, the oscillating circuit 12 also has the same structure as that of the variable tuning filter 11 and is constituted as shown in FIG. 4. In consideration of the addition of the predetermined amount of frequency offset f_{off} to the oscillating frequency f_{L} of the oscillating circuit 12, the resistance values of the resistors R1, R2 and R3 and the capacitance values of the capacitors C1 and C2 are set to be different from those of the variable tuning filter 11.

Any of switches S₁₁ to S_{1N-1}, S₂₁ to S_{2N-1}, and S₃₁ to S_{3N-1} constituting the oscillating circuit 12 is also controlled to be turned ON by the switch change-over circuit 15 depending on the result of the comparison between the count value Cout counted by the frequency counter 13 and the target count values Cmax and Cmin set by the control circuit 14. At this time, the switches S₁₁ to S_{1N-1}, S₂₁ to S_{2N-1}, and S₃₁ to S_{3N-1} constituting the variable tuning filter 11 and the switches S₁₁ to S_{1N-1}, S₂₁ to S_{2N-1}, and S₃₁ to S_{3N-1} constituting the oscillating circuit 12 which have corresponding signs to each other are synchronously turned ON.

When detecting that the count value is Cout>Cmax, the switch change-over circuit 15 changes over the switches S₂₁ to S_{2N-1} and S₃₁ to S_{3N-1} in such a manner that the resistance values of the resistors R2 and R3 are increased to decrease the count value Cout of the frequency counter 13. On the other hand, when detecting that the count value is Cout<Cmin, the switch change-over circuit 15 changes over the switches S₂₁ to S_{2N-1} and S₃₁ to S_{3N-1} in such a manner that the resistance values of the resistors R2 and R3 are decreased to increase the count value Cout of the frequency counter 13.

When detecting that the count value is Cmin≦Cout≦Cmax, the switch change-over circuit 15 stops the change-over operation of the switches S₂₁ to S_{2N-1} and S₃₁ to S_{3N-1}. At this time, the tuning frequency f_{F} of the variable tuning filter 11 is almost equal to the desirable received frequency fᵣ (f_{F}≈fᵣ). If resolutions of the resistors R2 and R3 are increased and the allowable error ±Δ of the frequency is reduced as greatly as possible, the tuning frequency f_{F} of the variable tuning filter 11 can be approximated to the desirable received frequency fᵣ as much as possible.

As described above in detail, in the present embodiment, the variable tuning filter 11 is constituted by the RC active filter including the resistance elements and any of the resistance elements is selected by changing over the switch to cause the tuning frequency f_{F} to be variable. Moreover, the oscillating circuit 12 having the same structure as that of the variable tuning filter 11 is provided and any of the resistance elements is selected by changing over the switch to cause the oscillating frequency f_{L} to be variable. The count value Cout of the oscillating frequency f_{L} of the oscillating circuit 12 is compared with the target count values Cmax and Cmin corresponding to the desirable received frequency fᵣ, and the switches of the variable tuning filter 11 and the oscillating circuit 12 are controlled depending on the result of the comparison.

More specifically, in the antenna input tuning circuit 3 according to the present embodiment, the oscillating frequency f_{L} of the oscillating circuit 12 which is monitored by the frequency counter 13 is compared with the desirable received frequency fᵣ which is preset by the control circuit 14 based on the respective frequency count values. The oscillating frequency f_{L} of the oscillating circuit 12 is caused to be variable by changing over the switch in such a manner that both of the frequencies are coincident with each other within an allowable error range. Correspondingly, the tuning frequency f_{F} of the variable tuning filter 11 is also caused to be variable by changing over the switch.

Consequently, it is possible to adjust the tuning frequency f_{F} of the variable tuning filter 11 to be coincident with the desirable received frequency fᵣ without using a variable capacitor and a variable capacitance diode which are hard to integrate. Therefore, it is possible to decrease the number of external components of an IC and to easily integrate the antenna input tuning circuit 3 and the radio receiver using the antenna input tuning circuit 3. According to the present embodiment, moreover, the MOSFET-C filter is not used. Therefore, it is also possible to eliminate a drawback that the dynamic range is reduced, the variation in a characteristic due to a manufacturing process is increased and a noise is made from the MOSFET.

In the antenna input tuning circuit 3 according to the present embodiment, the variable tuning filter 11 and the oscillating circuit 12 are disposed in the vicinity in the semiconductor chip. Consequently, it is possible to reduce the variation in a characteristic due to a manufacturing process between the variable tuning filter 11 and the oscillating circuit 12. Therefore, it is possible to eliminate a drawback that the tuning frequency f_{F} of the variable tuning filter 11 which is adjusted by monitoring the oscillating frequency f_{L} of the oscillating circuit 12 and the desirable received frequency fᵣ are shifted from each other due to the variation in the manufacturing process. Thus, it is possible to control the tuning frequency of the antenna input tuning circuit 3 more accurately.

In the antenna input tuning circuit 3 according to the present embodiment, the predetermined amount of frequency offset f_{off} is added to the oscillating frequency f_{L} of the oscillating circuit 12 to carry out the counting operation in the frequency counter 13. Consequently, the tuning frequency f_{F} of the variable tuning filter 11 and the oscillating frequency f_{L} of the oscillating circuit 12 can be caused to have a difference corresponding to the frequency offset f_{off} (f_{F}≠f_{L}). For this reason, it is possible to eliminate a drawback that the signal oscillated by the oscillating circuit 12 is sent around the variable tuning filter 11, thereby suppressing the generation of the noise.

Although the description has been given to the example in which any of the resistance elements R₁₁ to R_{1N}, R₂₁ to R_{2N}, and R₃₁ to R_{3N} is selected to cause the resistance value to be variable, thereby adjusting the tuning frequencies and the Q values of the variable tuning filter 11 and the oscillating circuit 12 in the embodiment, the present invention is not restricted thereto. For example, it is also possible to constitute the capacitors C1 and C2 by a plurality of capacitative elements respectively and to select any of the switches, thereby causing a capacitance value to be variable and adjusting the tuning frequencies and the Q values of the variable tuning filter 11 and the oscillating circuit 12.

While the description has been given by taking the two-stage amplifier type bandpass filter (DABP) as an example of the structures of the variable tuning filter 11 and the oscillating circuit 12 in the embodiment, the present invention is not restricted thereto. For example, in a bandpass filter of a Sallen-Key type, a multifeedback type, a state variable type, a biquad type, a differential input type or other types, it is also possible to constitute a resistor to be a component by a plurality of resistance elements, thereby selecting any of them by a switch or to constitute the capacitor by a plurality of capacitative elements, thereby selecting any of them by a switch.

Although the resistor R1 is constituted by the resistance elements R₁₁ to R_{1N} and any of them is selected by the switches S₁₁ to S_{1N-1}, and the resistors R2 and R3 are constituted by the resistance elements R₂₁ to R_{2N} and R₃₁ to R_{3N} and any of them is selected by the switches S₂₁ to S_{2N-1} and S₃₁ to S_{3N-1} in the embodiment described above, it is not necessary to always constitute all of the resistors R1, R2 and R3 by the resistance elements. For example, the resistor R1 for adjusting the Q value may be set to have a fixed value.

While the description has been given to the example in which the antenna input tuning circuit 3 is applied to the radio receiver in the embodiment, the radio receiver may be an AM radio receiver or an FM radio receiver. Furthermore, the example of the application of the antenna input tuning circuit 3 according to the present embodiment is not restricted to the radio receiver. For example, it is possible to apply the antenna input tuning circuit 3 to an electronic apparatus which is to select an electric wave having a desirable frequency from electric waves having various frequencies, for example, a television broadcast receiver.

Although the description has been given to the example in which the control circuit 14 sets the target upper limit count value Cmax and the target lower limit count value Cmin in the embodiment, the present invention is not restricted thereto. For example, it is also possible to previously hold the target upper limit count value Cmax and the target lower limit count value Cmin corresponding to each received frequency fᵣ in the switch change-over circuit 15. In this case, the control circuit 14 is not required.

In addition, the embodiment is only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for an antenna input tuning circuit for selecting a frequency for a radio frequency signal obtained upon receipt of broadcasting electric waves having various frequencies through an antenna, thereby choosing a signal having a desirable frequency.

What is claimed is:

1. An antenna input tuning circuit comprising:
a variable tuning filter having a plurality of resistance elements and a switch for selecting any of the resistance elements and constituted to determine a tuning frequency based on a resistance value of any of the resistance elements which is selected by the switch and a capacitance value of a capacitor;
an oscillating circuit constituted in the same manner as the variable tuning filter;
a frequency counter for counting an oscillating frequency of the oscillating circuit; and
a switch change-over circuit for comparing a count value counted by the frequency counter with a target count value corresponding to a desirable received frequency and controlling the switch depending on a result of the comparison,
wherein the variable tuning filter, the oscillating circuit, the frequency counter and the switch change-over circuit are integrated in the same semiconductor chip.

2. The antenna input tuning circuit according to claim 1, wherein the variable tuning filter and the oscillating circuit are disposed in the vicinity in the semiconductor chip.

3. The antenna input tuning circuit according to claim 2, wherein the frequency counter adds a predetermined amount of offset to the oscillating frequency of the oscillating circuit, thereby carrying out a counting operation.

4. An antenna input tuning circuit comprising:
a variable tuning filter having a plurality of capacitative elements and a switch for selecting any of the capacitative elements and constituted to determine a tuning frequency based on a capacitance value of any of the capacitative elements which is selected by the switch and a resistance value of a resistance element;
an oscillating circuit constituted in the same manner as the variable tuning filter;
a frequency counter for counting an oscillating frequency of the oscillating circuit; and
a switch change-over circuit for comparing a count value counted by the frequency counter with a target count value corresponding to a desirable received frequency and controlling the switch depending on a result of the comparison,
wherein the variable tuning filter, the oscillating circuit, the frequency counter and the switch change-over circuit are integrated in the same semiconductor chip.
